(19) United States
(12) Patent Application Publication
(10) Pub. No.: US 2009/0256051 A1
(43) Pub. Date: Oct. 15, 2009

(54) Recycled tire pad with appliance pod reccess guide

(75) Inventor: Jerome R. Mahoney, Colts Neck, NJ (US)

Correspondence Address: Deirdra M. Meagher;GlynnTech, Inc., 24 Mine Street, Flemington, NJ, 08822, US

(73) Assignee: iVoice Technologies, Inc.

(21) Appl. No.: 12/082,315

(22) Filed: Apr. 10, 2008

(51) Int. Cl. F16M 13/00

(52) U.S. Cl. 248/633

(57) ABSTRACT

The present invention relates to a recycled tire pad with appliance pod recess guide which includes at least one anti-vibration pad composed entirely of fused shredded rubber from used tires. The anti-vibration pad includes at least one sidewall, a top and a bottom. The top includes a top recess and a plurality of protrusions located in the top recess, which is adapted for placement of a pod of a potentially vibrating appliance. The bottom has a plurality of bottom recesses extending at least half way into the at least one anti-vibration pad and is adapted for placement on a surface where the potentially vibrating appliance is placed. The at least one anti-vibration pad reduces noise and vibration of the potentially vibrating appliance when the anti-vibration pad is placed under said potentially vibrating appliance wherein each of the pods of the potentially vibrating appliance is placed in the top recess of the at least one anti-vibration pad. The protrusions may be textured.

### BACKGROUND OF INVENTION

a. Field of Invention

The invention relates generally to recycled tire anti-vibration pads for reducing noise and vibration. More specifically, the pads include a plurality of protrusions within a top recess and a plurality of bottom recesses. The top recess is adapted for placement of a pod of a potentially vibrating appliance. The pads are composed entirely of fused shredded rubber from used tires.

b. Description of Related Art

The following patents are representative of anti-vibration pads:

U.S. Pat. No. 7,300,032 B2 to Williams et al. describes a base pad which is for supporting mechanical machines and equipment and which is configured such that it reduces the noise and vibration emanating from these machines. The pad is constructed entirely from shredded and comminuted rubber tires and is configured such that it provides for the efficient run-off and/or draining of any moisture generated from under the machine unit.

U.S. Pat. No. 6,692,047 B1 to Solon describes a flexible impact energy absorption resilient and flexible rubber strip accessory has an adhesive layer for affixing it to an exterior curved automobile body surface. An inexpensive preferred embodiment is formed using tire tread strips cut from the carcasses of discarded automobile tires. Thus, steel belted tires provide embedded reinforcement for absorbing higher levels of impact energy without any visible damage to the tread strip or the adjacent car body surface upon which it is affixed. This accessory has an adhesive layer for attachment to a car surface having a manually protective paper or plastic cover so that it may be retrofit upon an exterior surface of an automobile without requiring any special tools. The accessory is universally adaptable to a large range of automobile body styles.

U.S. Pat. No. 6,444,067 B1 to Bove et al. describes a process for manufacturing structures from worn out tires and a parking stop made by that process. Sidewalls are cut from the tire leaving a circular strip, which is cut transversely to produce an elongated approximately rectangular strip. Spaced slits are cut into the long edges of the strips to form slats suitable for use in manufacturing structures. Two slats are bonded together in a face-to-face arrangement to form a unitary pair of bonded slats. Additional pairs of slats are then bonded to the first pair of slats. All slats are bonded with similar sides in contact; that is, tread side to tread side or inside to inside. The resulting beam can have adjacent corners removed to provide a parking stop configuration. Preferably, the slats are bonded with an elastomer or mechanical fasteners such as ring nails or staples. A thick elastomer, having a thickness of at least about ⅛ inch may be coated over the beam. Beams may be combined to form guard rails, walls, panels, etc.

U.S. Pat. No. 6,050,539 to Millen describes a support pad which is provided having a lightweight core component defining an essentially open space between side walls thereof. An interlocking pattern, such as alternating bottom recesses and extensions, are defined along the side walls of the core component. A hard formable shell material, such as concrete, generally surrounds the core component along the side walls and upper surface thereof. The shell material forms within the bottom recesses along at least one of the side walls and non-movably sets the core component within the shell material. The interlocking pattern or bottom recesses defined on the sides of the core component are configured so that any number of pattern of core components can be interconnected depending on the sides and configuration of the desired support pad.

U.S. Pat. No. 5,834,083 to Pignataro, Jr. describes used tires that are sorted on-site to separate those which are still good from those that are scrap. At the site, the sidewalls are separated from each scrap tire and the remaining tire portion is slit transversely and laid flat, stacked one atop the other. The stack is transported by vehicle from the site to a central processing facility that shears the tire portions to a uniform width and thickness. The uniformly dimensioned tire portions are then connected into strips by male/female dovetail cuts. Two strips are bonded together at their flat inner tire sides to form a two-ply tread strip. The two-ply tread strips are then used in construction, building component manufacture, fencing or landscaping; the two-ply treads are more flexible then lumber. The sidewalls are used as landfill or grounds cover in landscaping.

U.S. Pat. No. 5,573,220 to Whittaker et al. describes a heavy duty vibration absorbing and leveling machinery foundation mount and a method for turning the same, the mount consisting of a rigid horizontal platform having a plurality of vibration absorbing legs. A leveler is mounted in the central region of the platform having a vertically adjustable riser, and the legs are formed by pockets housing a composite vibration absorbing material extending below the platform and engaging the surface upon which the machinery mount is supported which may be tuned to most effectively absorb the vibration to which the mount is subjected.

U.S. Pat. No. 4,493,471 to McInnis describes a speaker stand for supporting a speaker enclosure on the floor comprising a rigid planar member (11) supporting a waffled cushion pad (12) on the top surface with the pad including peaks 17 and valleys 19. Semire-silient rails (13,14,15,16) positioned to the side of said pad support and stabilize the speaker enclosure such that the pad is depressed sufficiently to form air pockets between the pad and speaker enclosure in the areas of the valleys to attenuate vibratory motion and acoustic sound wave transmissions between the speaker and floor.

U.S. Pat. No. 4,273,213 to Munz describes the present invention which is concerned with an element for the sonic and vibratory absorption, comprising a ledge having ribs of flexible material longitudinally extending along the top and bottom sides, with the top-side ribs over the bottom-side ribs being arranged in staggered relationship. According to the invention, such an element is improved in that provided between respectively two ribs of approximately trapezoidal cross-section is another rib equally of approximately trapezoidal cross-section of an inferior height, which continues to extend through the central area of the element upwardly and downwardly, respectively, in the respective rib of greater height, and that at least on one longitudinal side of the element a stop is provided extending over the entire length of the element.

U.S. Pat. No. 4,002,315 to Van Goubergen describes the invention which concerns a vibration damping mat having on either side projections that, when stacking a number of such mats, so engage each other that the assembly behaves like a single thicker mat having the lateral stability of a single mat and having the same differentiated damping effect for different vibration amplitudes as a single mat, however with a different absorption percentage.

Notwithstanding the prior art, the present invention is neither taught nor rendered obvious thereby.

### SUMMARY OF THE INVENTION

The present invention relates to a recycled tire pad with appliance pod recess guide which includes at least one anti-vibration pad composed entirely of fused shredded rubber from used tires. The anti-vibration pad includes at least one sidewall, a top and a bottom. The top includes a top recess and a plurality of protrusions located in the top recess, which is adapted for placement of a pod of a potentially vibrating appliance.

The bottom has a plurality of bottom recesses extending at least half way into the at least one anti-vibration pad and is adapted for placement on a surface where the potentially vibrating appliance is placed. The at least one anti-vibration pad reduces noise and vibration of the potentially vibrating appliance when the anti-vibration pad is placed under said potentially vibrating appliance wherein each of the pods of the potentially vibrating appliance is placed in the top recess of the at least one anti-vibration pad.

In some embodiments, the plurality of protrusions is in a fixed pattern. In other embodiments, the plurality of protrusions is in a symmetrical predetermined pattern. The shape of the protrusions is selected from the group consisting of circular, oval, square, rectangular, triangular, hexagonal, octagonal, polygonal, and combinations thereof.

In some embodiments, the plurality of bottom recesses is in a fixed pattern while in other embodiments, the plurality of bottom recesses is in a symmetrical predetermined pattern. The shape of the plurality of bottom recesses is selected from the group consisting of circular, oval, square, rectangular, triangular, hexagonal, octagonal, polygonal, and combinations thereof. In some embodiments, each of the bottom recesses includes a top and a bottom and wherein an area of the bottom recess from a two-dimensional perspective parallel to the bottom of the at least one anti-vibration pad increases from a bottom of the bottom recess to a top of the bottom recess.

In some preferred embodiments, an extended footprint view from the top is selected from the group consisting of circular, oval, square, rectangular, triangular, hexagonal, octagonal and polygonal.

In other embodiments, the least one anti-vibration pad is textured in a portion separate from the plurality of bottom recesses.

In another preferred embodiment of the present invention, a recycled tire pad with appliance pod recess guide has at least one anti-vibration pad composed entirely of fused shredded rubber from used tires. Each anti-vibration pad has at least one sidewall, a top and a bottom. The top includes a top recess and a plurality of textured protrusions located in the top recess, which is adapted for placement of a pod of a potentially vibrating appliance.

The bottom has a plurality of bottom recesses extending at least half way into the at least one anti-vibration pad and is adapted for placement on a surface where the potentially vibrating appliance is placed. The at least one anti-vibration pad reduces noise and vibration of the potentially vibrating appliance when the anti-vibration pad is placed under said potentially vibrating appliance wherein each of the pods of the potentially vibrating appliance is placed in the top recess of the at least one anti-vibration pad.

In some embodiments, the plurality of textured protrusions is in a fixed pattern. In other embodiments, the plurality of textured protrusions is in a symmetrical predetermined pattern. The shape of the textured protrusions is selected from the group consisting of circular, oval, square, rectangular, triangular, hexagonal, octagonal, polygonal, and combinations thereof.

In some embodiments, the plurality of bottom recesses is in a fixed pattern while in other embodiments, the plurality of bottom recesses is in a symmetrical predetermined pattern. The shape of the is selected from the group consisting of circular, oval, square, rectangular, triangular, hexagonal, octagonal, polygonal, and combinations thereof.

In some preferred embodiments, in which of the bottom recesses has a top and a bottom, the area of the bottom recess from a two-dimensional perspective parallel to the bottom of the at least one anti-vibration pad increases from a bottom of the bottom recess to a top of the bottom recess.

An extended footprint view from the top is selected from the group consisting of circular, oval, square, rectangular, triangular, hexagonal and polygonal.

In some preferred embodiments, the at least one anti-vibration pad is textured in its entirety.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIGS. 1, 2 and 3 are a top view, a bottom view and a side view, respectively, of one embodiment of a present invention recycled tire pad with appliance pod recess guide, illustrating a symmetrical pattern for a plurality of protrusions and a fixed pattern for a plurality of bottom recesses, as well as a hexagonal footprint for an appliance pod;

FIGS. 4, 5 and 6 are a top view, a bottom view and a side view, respectively, of another embodiment of a present invention recycled tire pad with appliance pod recess guide, illustrating symmetrical predetermined patterns for a plurality of protrusions and a plurality of bottom recesses, as well as a circular footprint for an appliance pod;

FIGS. 7, 8 and 9 are a top view, a bottom view and a side view, respectively, of yet another embodiment of a present invention recycled tire pad with appliance pod recess guide, illustrating a symmetrical predetermined pattern for a plurality of protrusions and a fixed pattern for a plurality of bottom recesses, as well as a circular pod top recess guide;

FIGS. 10, 11 and 12 are a top view, a bottom view and a side view, respectively, of yet another embodiment of a present invention recycled tire pad with appliance pod recess guide, illustrating a hexagonal pod top recess guide; and,

FIGS. 13, 14 and 15 are a top view, a bottom view and a side view, respectively, of yet another embodiment of a present invention recycled tire pad with appliance pod recess guide, illustrating fixed patterns for a plurality of protrusions and a plurality of recesses, as well a different shape for the extended footprint from a top perspective.

### DETAILED DESCRIPTION OF THE EMBODIMENTS

The present invention relates to a recycled tire pad with appliance pod recess guide which includes at least one anti-vibration pad composed entirely of fused shredded rubber from used tires. The anti-vibration pad includes at least one sidewall, a top and a bottom. The top includes a top recess and a plurality of protrusions located in the top recess, which is adapted for placement of a pod of a potentially vibrating appliance.

The bottom has a plurality of bottom recesses extending at least half way into the at least one anti-vibration pad and is adapted for placement on a surface where the potentially vibrating appliance is placed. The at least one anti-vibration pad reduces noise and vibration of the potentially vibrating appliance when the anti-vibration pad is placed under said potentially vibrating appliance wherein each of the pods of the potentially vibrating appliance is placed in the top recess of the at least one anti-vibration pad.

The potentially vibrating appliance may include washers or any appliance which has pods for leveling out the load. By “pods” is meant feet in the corners of an appliance which may be adjusted for balancing, depending upon the surface where the appliance is placed. In addition to reducing noise and vibration, a reduction in energy consumption, component wear and costly repairs is also accomplished by the use of the anti-vibration pads.

The plurality of protrusions is in a fixed pattern or in a symmetrical predetermined pattern. The shape of the protrusions may be circular, oval, square, rectangular, triangular, hexagonal, octagonal, polygonal, and combinations thereof. The plurality of protrusions facilitates reduction of noise and vibration. The plurality of protrusions may be textured.

The plurality of bottom recesses is in a fixed pattern or in a symmetrical predetermined pattern. The shape of the plurality of bottom recesses may be circular, oval, square, rectangular, triangular, hexagonal, octagonal, polygonal, and combinations thereof. The plurality of bottom recesses facilitates reduction of noise and vibration.

Each of the bottom recesses includes a top and a bottom. An area of the bottom recess from a two-dimensional perspective parallel to the bottom of the at least one anti-vibration pad may be tapered and thus increases from a bottom of the bottom recess to a top of the bottom recess. In other embodiments, the area of the bottom recess from a two-dimensional perspective remains constant.

An extended footprint view from the top is selected may be circular, oval, square, rectangular, triangular, hexagonal, octagonal and polygonal. Furthermore, the anti-vibration pad may be entirely textured.

The fused shredded rubber from used tires, which composes the anti-vibration pad, may be obtained from waste dumps and recycling facilities providing scrap tires. A mold is previously made allowing for the protrusions and the bottom recesses. The scrap tires are heat-pressed into a desired size and then placed into the mold through injection and/or pressing. Upon cooling, the mod is removed to provide the anti-vibration pad having a plurality of protrusions on the top and a plurality of bottom recesses on the bottom.

The use of the shredded rubber from used tires provides greening by saving the environment from the breakdown of the rubber and potential fire hazards by chemical reactions of the rubber with soil and air. Thus, a waste disposal problem and an environmental problem are eliminated by use of scrap tires.

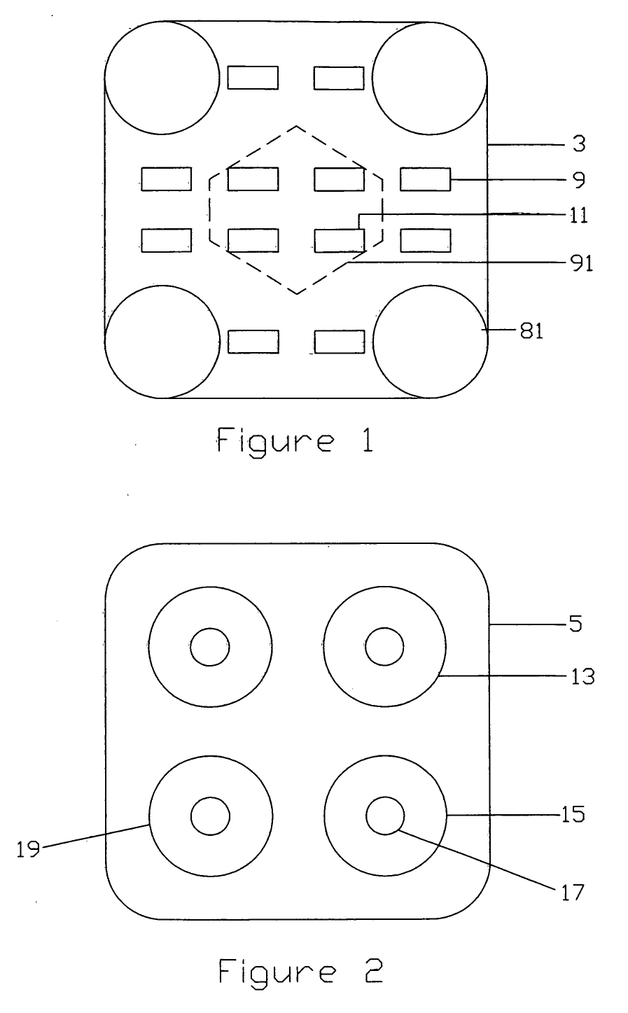

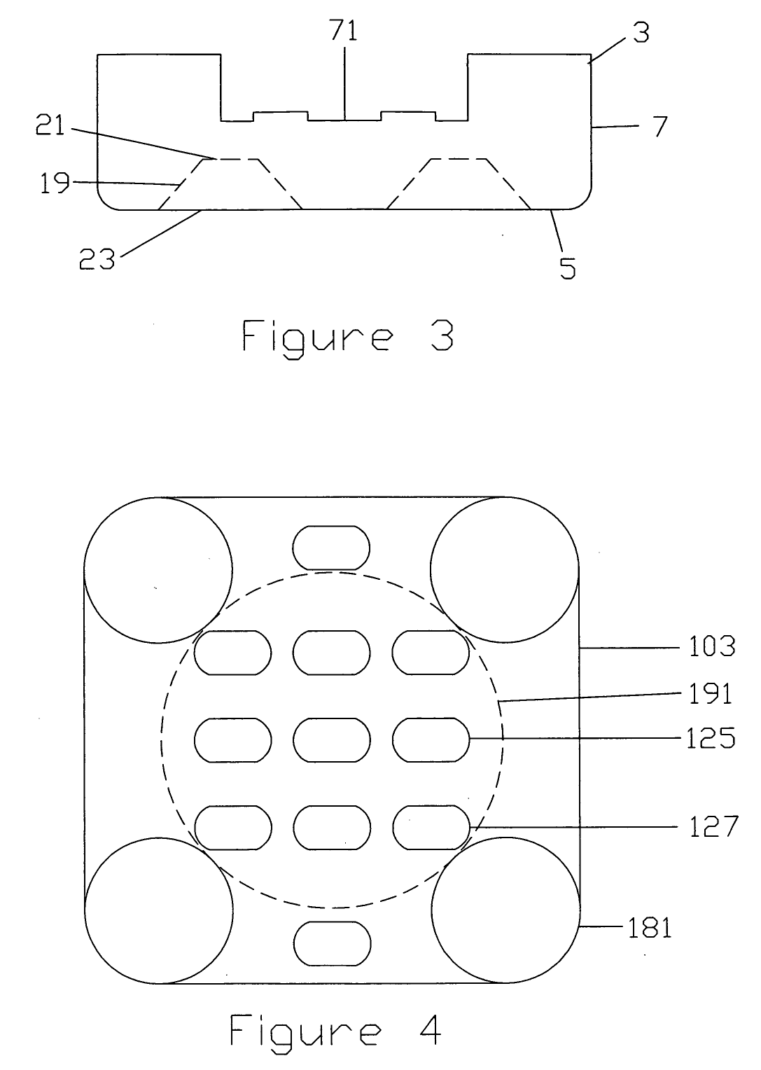

Referring now to the drawings wherein like reference numerals designate corresponding parts throughout the several views, FIGS. 1, 2 and 3 are a top view, a bottom view and a side view, respectively, of one embodiment of a present invention recycled tire pad with appliance pod recess guide, illustrating a symmetrical pattern for a plurality of protrusions 9, 11 and a fixed pattern for a plurality of bottom recesses 13, 15, 19.

An anti-vibration pad 1 includes at least one sidewall 7, a top 3 and a bottom 5. The top 3 includes a top recess 71 and a plurality of protrusions 9, 11 located in the top recess 71, which is adapted for placement of a pod 91 of a potentially vibrating appliance. The pod 91 is securely positioned by the corner walls 81 of the anti-vibration pad 1. In this embodiment, the pod 91 is hexagonal.

The bottom 5 has a plurality of bottom recesses 13, 15 extending at least half way into the at least one anti-vibration pad 1 and is adapted for placement on a surface where the potentially vibrating appliance is placed. The at least one anti-vibration pad 1 reduces noise and vibration of the potentially vibrating appliance when the at least one anti-vibration pad 1 top recess 71 is placed under one of the pods of a potentially vibrating appliance. Typically, there are four pods and four anti-vibration pads.

In this embodiment, the plurality of protrusions 9, 11 is in a symmetrical pattern of rectangles. Although the protrusions 9, 11 are shown as rectangles, the shape of the protrusions may be circular, oval, square, rectangular, triangular, hexagonal, octagonal, polygonal, and combinations thereof. The protrusions 9, 11 may be textured.

In this embodiment, the plurality of bottom recesses 13, 15, 19 is in a fixed pattern of two circles each across the width and length. Although the bottom recesses are shown as circles, the shape of the bottom recesses 13, 15, 19 may be circular, oval, square, rectangular, triangular, hexagonal, octagonal, polygonal, and combinations thereof. Each of the bottom recesses 13, 15, 19 includes a top 23 and a bottom 21. The bottom recesses are tapered as illustrated by a smaller dimensioned circle 17 within the bottom recess 15. Thus, an area of each bottom recess 13, 15, 19 from a two-dimensional perspective parallel to the bottom 5 of the at least one anti-vibration pad 1 increases from the bottom 21 of the bottom recess 19 to the top 23 of the bottom recess 19.

In this embodiment, an extended footprint from a top view 3 is square. However, the extended footprint view from the top may be circular, oval, square, rectangular, triangular, hexagonal, octagonal and polygonal. The least one anti-vibration pad 1 may be textured in a portion separate from the plurality of protrusions.

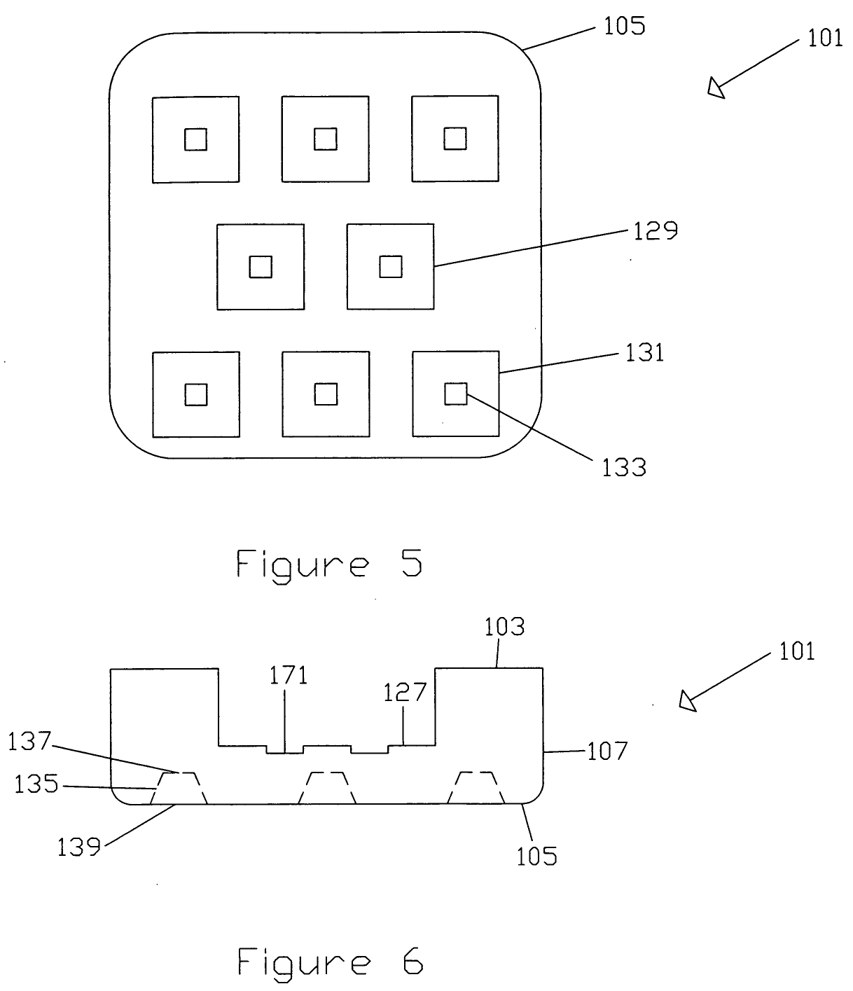

FIGS. 4, 5 and 6 are a top view, a bottom view and a side view, respectively, of another embodiment of a present invention recycled tire pad with appliance pod recess guide, illustrating symmetrical predetermined patterns for a plurality of protrusions 125, 127 and a plurality of bottom recesses 129, 133, 135.

An anti-vibration pad 101 includes at least one sidewall 107, a top 103 and a bottom 105. The top 103 includes a top recess 171 and a plurality of protrusions 125, 127 located in the top recess 171, which is adapted for placement of a pod 191 of a potentially vibrating appliance. The pod 191 is securely positioned by the corner walls 181 of the anti-vibration pad 101. In this embodiment, the pod is circular.

The top 103 has a plurality of protrusions 125, 127 and is adapted for placement under a potentially vibrating appliance. The bottom 105 has a plurality of bottom recesses 129, 133, 135 extending at least half way into the at least one anti-vibration pad 101 and is adapted for placement on a surface where the potentially vibrating appliance is placed. The at least one anti-vibration pad 101 reduces noise and vibration of the potentially vibrating appliance when the at least one anti-vibration pad 101 top recess 171 is placed under one of the pods of a potentially vibrating appliance. Typically, there are four pods and four anti-vibration pads.

In this embodiment, the plurality of protrusions 125, 127 is in a symmetrical predetermined pattern of an increasing number of octagons. Although the protrusions 125, 127 are shown as octagons, the shape of the protrusions may be circular, oval, square, rectangular, triangular, hexagonal, octagonal, polygonal, and combinations thereof. The protrusions 125, 127 may be textured.

In this embodiment, the plurality of bottom recesses 129, 131, 135 is in a symmetrical predetermined pattern of staggered placement of squares within the length. Although the bottom recesses are shown as squares, the shape of the bottom recesses 129, 131, 135 may be circular, oval, square, rectangular, triangular, hexagonal, octagonal, polygonal, and combinations thereof. Each of the bottom recesses 129, 131, 135 includes a top 139 and a bottom 137. The bottom recesses are tapered as illustrated by a smaller dimensioned circle 133 within the bottom recess 131. Thus, an area of each bottom recess 129, 131, 135 from a two-dimensional perspective parallel to the bottom 105 of the at least one anti-vibration pad 101 increases from the bottom 137 of the bottom recess 135 to the top 139 of the bottom recess 135.

In this embodiment, an extended footprint from a top 103 view is square. However, the extended footprint view from the top may be circular, oval, square, rectangular, triangular, hexagonal, octagonal and polygonal.

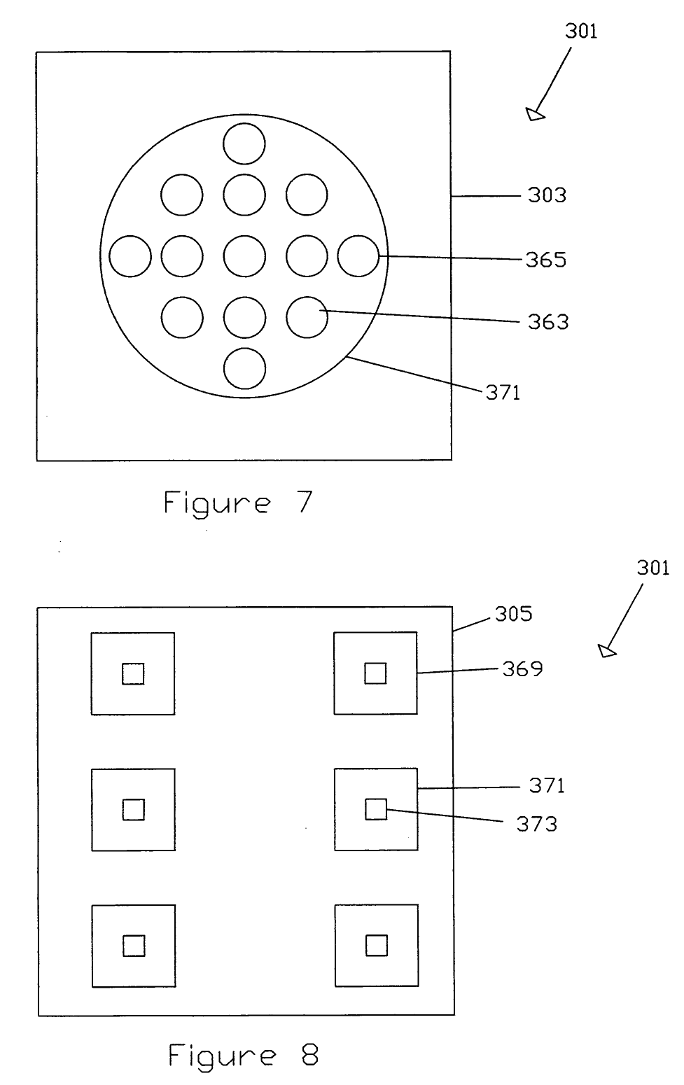

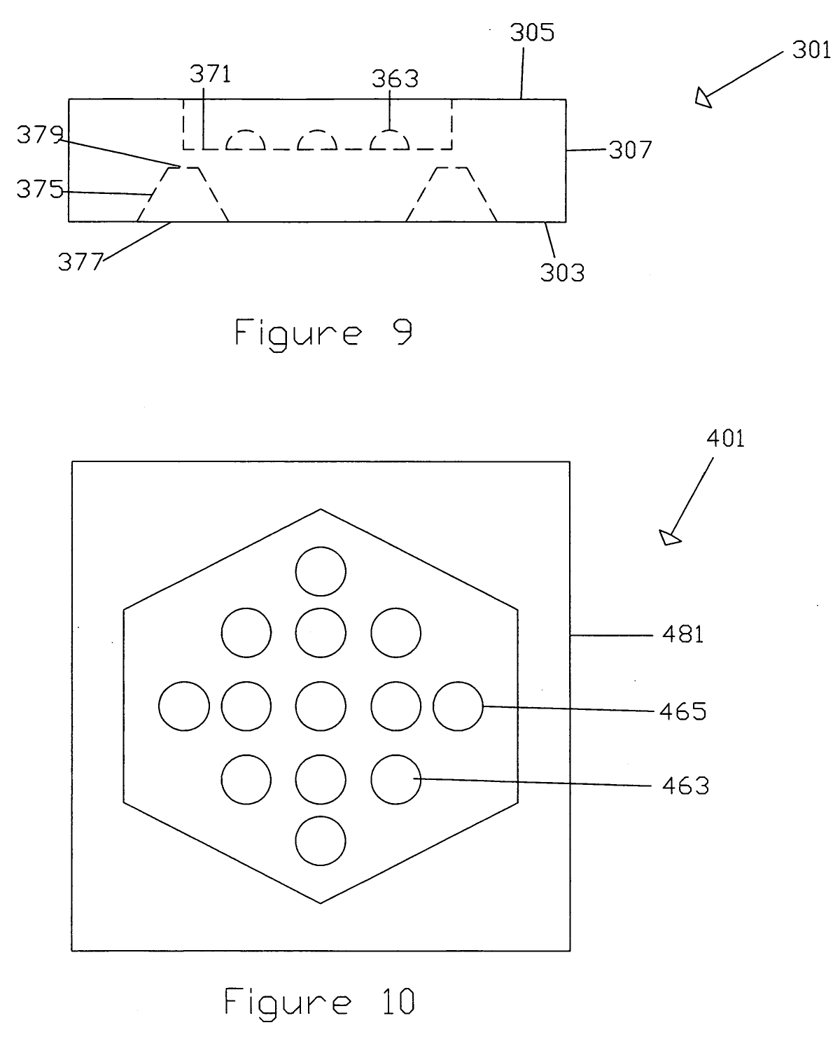

FIGS. 7, 8 and 9 are a top view, a bottom view and a side view, respectively, of yet another embodiment of a present invention recycled tire pad with appliance pod recess guide, illustrating a symmetrical predetermined pattern for a plurality of protrusions 363, 365 and a fixed pattern for a plurality of recesses 369, 371, 375, as well as a circular footprint for a pod top recess guide 371.

An anti-vibration pad 301 includes at least one sidewall 307, a top 303 and a bottom 305. The top 303 includes a top recess 371 and a plurality of protrusions 363, 365 located in the top recess 371, which is adapted for placement of a pod of a potentially vibrating appliance. The top recess 371, which is sized and shaped to receive a circular pod securely positions the pod within the top recess 371.

The bottom 305 has a plurality of bottom recesses 369, 371, 375 extending at least half way into the at least one anti-vibration pad 301 and is adapted for placement on a surface where the potentially vibrating appliance is placed. The at least one anti-vibration pad 301 reduces noise and vibration of the potentially vibrating appliance when one of the pods of a potentially vibrating appliance is placed within the at least one anti-vibration pad 301 top recess 371. Typically, there are four pods and four anti-vibration pads.

In this embodiment, the plurality of protrusions 363, 365 is in a symmetrical predetermined pattern of circles. The protrusions 363, 365 may be textured.

In this embodiment, the plurality of bottom recesses 369, 371, 375 is in a fixed pattern of two squares in width and three squares in length. Although the bottom recesses 369, 371, 375 are shown as squares, the shape of the bottom recesses 369, 371, 375 may be circular, oval, square, rectangular, triangular, hexagonal, octagonal, polygonal, and combinations thereof.

Each of the bottom recesses 369, 371, 375 includes a top 377 and a bottom 379. In this embodiment, the bottom recesses are tapered as illustrated by a smaller dimensioned circle 373 within the bottom recess 371. Thus, an area of each bottom recess 369, 371, 375 from a two-dimensional perspective parallel to the bottom 305 of the at least one anti-vibration pad 301 increases from the bottom 379 of the bottom recess 375 to the top 377 of the bottom recess 375.

In this embodiment, an extended footprint from a top 303 view is square. However, the extended footprint view from the top may be circular, oval, square, rectangular, triangular, hexagonal, octagonal and polygonal.

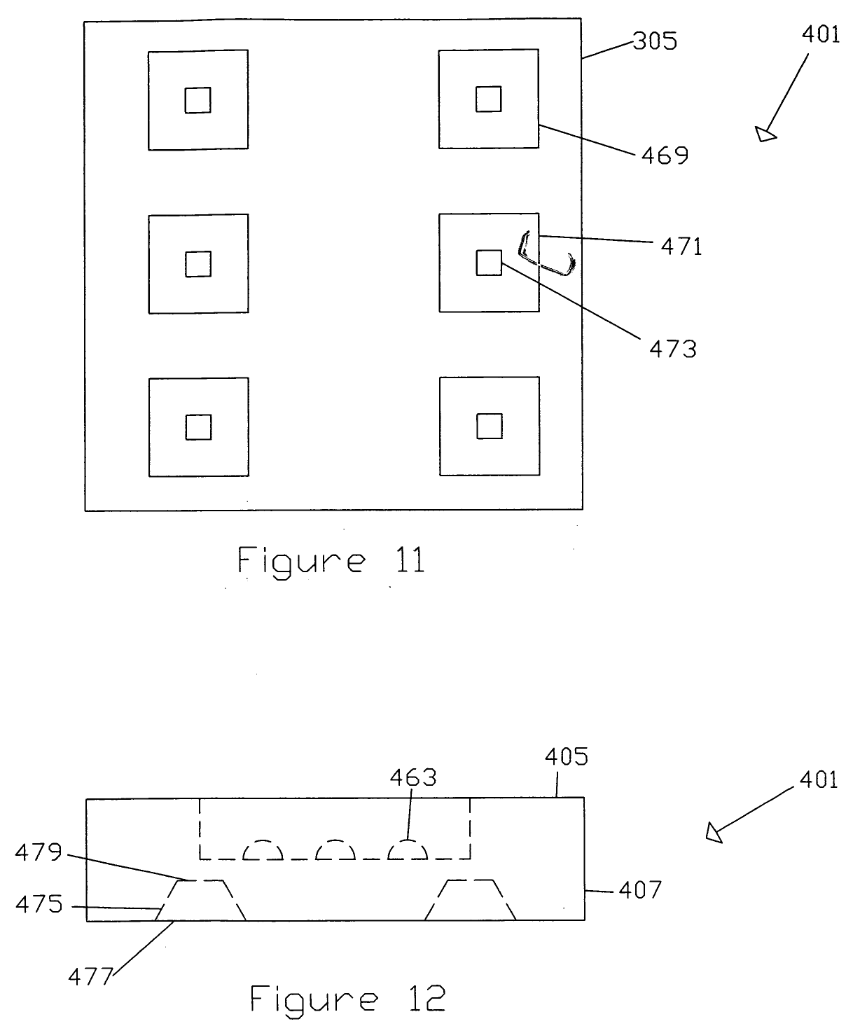

FIGS. 10, 11 and 12 are a top view, a bottom view and a side view, respectively, of yet another embodiment of a present invention recycled tire pad with appliance pod recess guide, illustrating a hexagonal footprint for a pod top recess guide.

An anti-vibration pad 401 includes at least one sidewall 407, a top 403 and a bottom 405. The top 403 includes a top recess 471 and a plurality of protrusions 463, 465 located in the top recess 471, which is adapted for placement of a pod of a potentially vibrating appliance. The top recess 471, which is sized and shaped to receive a hexagonal pod, securely positions the pod within the top recess 471.

The bottom 405 has a plurality of bottom recesses 469, 471, 475 extending at least half way into the at least one anti-vibration pad 401 and is adapted for placement on a surface where the potentially vibrating appliance is placed. The at least one anti-vibration pad 401 reduces noise and vibration of the potentially vibrating appliance when one of the pods of a potentially vibrating appliance is placed within the at least one anti-vibration pad 401 top recess 471. Typically, there are four pods and four anti-vibration pads.

In this embodiment, the plurality of protrusions 463, 465 is in a symmetrical pattern of circles. The protrusions 463, 465 may be textured.

In this embodiment, the plurality of bottom recesses 469, 471, 475 is in a fixed pattern of two squares in width and three squares in length. Although the bottom recesses 469, 471, 475 are shown as squares, the shape of the bottom recesses 469, 471, 475 may be circular, oval, square, rectangular, triangular, hexagonal, octagonal, polygonal, and combinations thereof.

Each of the bottom recesses 469, 471, 475 includes a top 477 and a bottom 479. In this embodiment, the bottom recesses are tapered as illustrated by a smaller dimensioned square 474 within the bottom recess 471. Thus, an area of each bottom recess 469, 471, 475 from a two-dimensional perspective parallel to the bottom 405 of the at least one anti-vibration pad 401 increases from the bottom 479 of the bottom recess 475 to the top 477 of the bottom recess 475.

In this embodiment, an extended footprint from a top 403 view is square. However, the extended footprint view from the top may be circular, oval, square, rectangular, triangular, hexagonal, octagonal and polygonal.

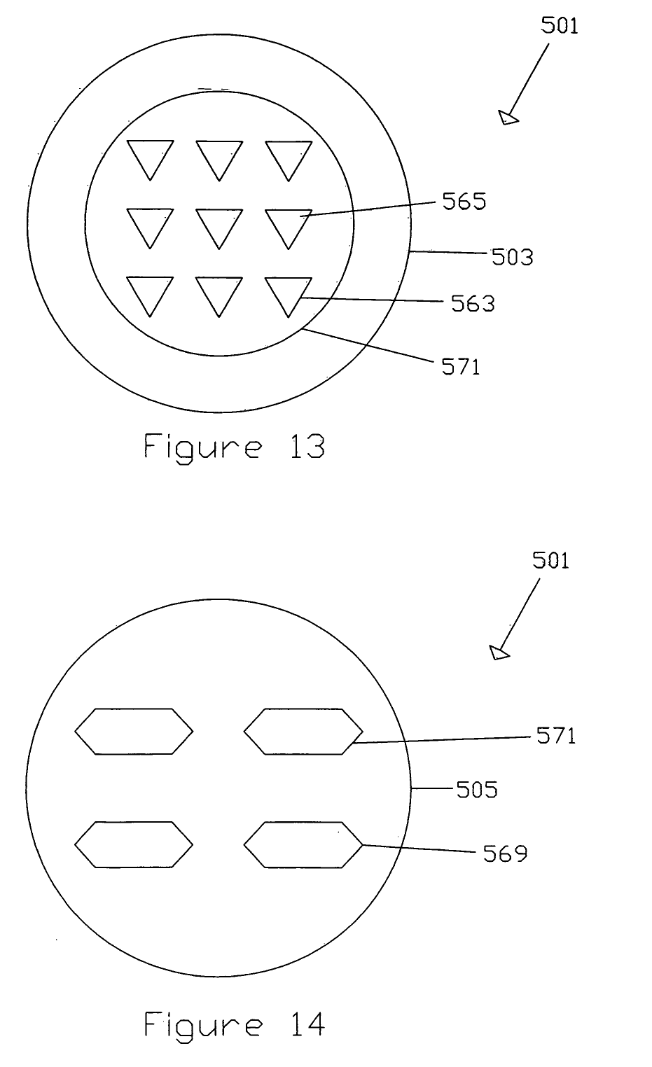

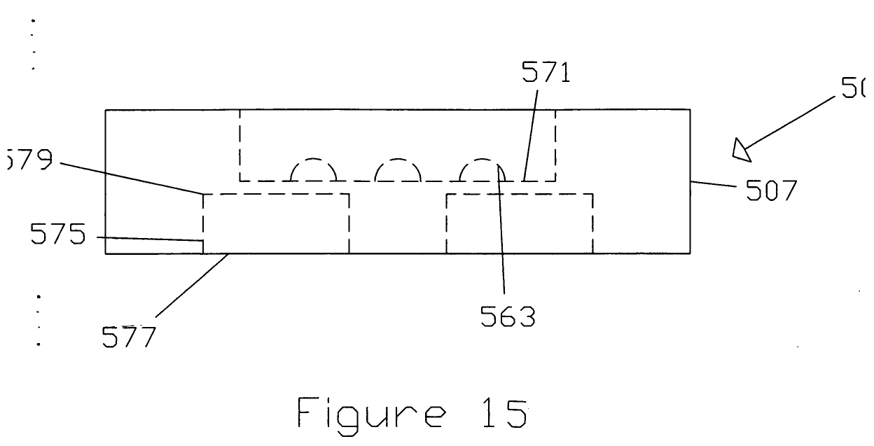

FIGS. 13, 14 and 15 are a top view, a bottom view and a side view, respectively, of yet another embodiment of a present invention recycled tire pad with appliance pod recess guide, illustrating a different shape for the extended footprint from a top perspective.

An anti-vibration pad 501 includes at least one sidewall 507, a top 503 and a bottom 505. The top 503 includes a top recess 571 and a plurality of protrusions 563, 565 located in the top recess 571, which is adapted for placement of a pod of a potentially vibrating appliance. The top recess 571, which is sized and shaped to receive a circular pod, securely positions the pod within the top recess 571.

The bottom 505 has a plurality of bottom recesses 569, 571, 575 extending at least half way into the at least one anti-vibration pad 501 and is adapted for placement on a surface where the potentially vibrating appliance is placed. The at least one anti-vibration pad 501 reduces noise and vibration of the potentially vibrating appliance when one of the pods of a potentially vibrating appliance is placed within the at least one anti-vibration pad 501 top recess 571. Typically, there are four pods and four anti-vibration pads.

In this embodiment, the plurality of protrusions 563, 565 is in a fixed pattern of three triangles across each of the length and the width. The protrusions 563, 565 may be textured. noise and vibration of the potentially vibrating appliance when one of the pods of a potentially vibrating appliance is placed within the at least one anti-vibration pad 501 top recess 571. Typically, there are four pods and four anti-vibration pads.

In this embodiment, the plurality of protrusions 563, 565 is in a fixed pattern of three triangles across each of the length and the width. The protrusions 563, 565 may be textured.

In this embodiment, the plurality of bottom recesses 569, 571, 575 is in a fixed pattern of two hexagons in width and two hexagons in length. Although the bottom recesses 569, 571, 575 are shown as hexagons, the shape of the bottom recesses 569, 571, 575 may be circular, oval, square, rectangular, triangular, hexagonal, octagonal, polygonal, and combinations thereof.

Each of the bottom recesses 569, 571, 575 includes a top 577 and a bottom 579. In this embodiment, the bottom recesses are not tapered, so that an area of each bottom recess 569, 571, 575 from a two-dimensional perspective relative to the top 503 of the anti-vibration pad 501 remains constant from the bottom 579 of the recess 575 to the top 577 of the recess 575.

In this embodiment, an extended footprint from a top 503 view is circular. However, the extended footprint view from the top may be circular, oval, square, rectangular, triangular, hexagonal, octagonal and polygonal.

To summarize, the present invention thus provides an anti-vibration pad having a pod recess guide for reducing noise and vibration of a potentially vibrating appliance, most particularly a washer. A top recess including protrusions is a guide for an appliance pod.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims. For example, in some preferred embodiments, before being melted and fused, the shredded rubber from used tires may be intermixed with an appropriate binding material, such as those used in the insides of a baseball, or any other available binder that works with rubber used in tires.

What is claimed is:

1. A recycled tire pad with appliance pod recess guide which comprises:
at least one anti-vibration pad composed entirely of fused shredded rubber from used tires, each of said anti-vibration pads including at least one sidewall, a top and a bottom;
wherein said top includes a top recess and a plurality of protrusions located in said at least one top recess, said top recess being adapted for placement of a pod of a potentially vibrating appliance;
wherein said bottom includes a plurality of bottom recesses extending at least half way into said at least one anti-vibration pad and is adapted for placement on a surface where said potentially vibrating appliance is placed;
such that said at least one anti-vibration pad reduces noise and vibration of said potentially vibrating appliance when said anti-vibration pad is placed under said potentially vibrating appliance wherein each of said pods of said potentially vibrating appliance is placed in said top recess of each of said at least one anti-vibration pad.

2. The recycled tire pad with appliance pod recess guide of claim 1 wherein shape of said top recess is selected from the group consisting of circular, square and hexagonal.

3. The recycled tire pad with appliance pod recess guide of claim 1 wherein said plurality of protrusions is in a fixed pattern.

4. The recycled tire pad with appliance pod recess guide of claim 1 wherein said plurality of protrusions is in a symmetrical predetermined pattern.

5. The recycled tire pad with appliance pod recess guide of claim 1 wherein shape of said protrusions is selected from the group consisting of circular, oval, square, rectangular, triangular, hexagonal, octagonal, polygonal, and combinations thereof.

6. The recycled tire pad with appliance pod recess guide of claim 1 wherein said plurality of bottom recesses is in a fixed pattern.

7. The recycled tire pad with appliance pod recess guide of claim 1 wherein said plurality of bottom recesses is in a symmetrical predetermined pattern.

8. The recycled tire pad with appliance pod recess guide of claim 1 wherein shape of said bottom recesses is selected from the group consisting of circular, oval, square, rectangular, triangular, hexagonal, octagonal, polygonal, and combinations thereof.

9. The recycled tire pad with appliance pod recess guide of claim 1 wherein an extended footprint view from said top is selected from the group consisting of circular, oval, square, rectangular, triangular, hexagonal, octagonal and polygonal.

10. The recycled tire pad with appliance pod recess guide of claim 1 wherein each of said bottom recesses includes a top and a bottom and wherein an area of said bottom recess from a two-dimensional perspective parallel to said bottom of said at least one anti-vibration pad increases from said bottom of said bottom recess to said top of said bottom recess.

11. A recycled tire pad with appliance pod recess guide which comprises:
at least one anti-vibration pad composed entirely of fused shredded rubber from used tires and including at least one sidewall, a top and a bottom;
wherein said top includes a top recess and a plurality of protrusions located in said at least one top recess, said top recess being adapted for placement of a pod of a potentially vibrating appliance;
wherein said bottom includes a plurality of bottom recesses extending at least half way into said at least one anti-vibration pad and is adapted for placement on a surface where said potentially vibrating appliance is placed;
such that said at least one anti-vibration pad reduces noise and vibration of said potentially vibrating appliance when said anti-vibration pad is placed under said potentially vibrating appliance wherein each of said pods of said potentially vibrating appliance is placed in said top recess of each of said at least one anti-vibration pad.

12. The recycled tire pad with appliance pod recess guide of claim 11 wherein shape of said top recess is selected from the group consisting of circular, square and hexagonal.

13. The recycled tire pad with appliance pod recess guide of claim 11 wherein a top view footprint of said portion of said at least one anti-vibration pad separate from said top recess is selected from the group consisting of circular, square and rectangular.

14. The recycled tire pad with appliance pod recess guide of claim 11 wherein said plurality of textured protrusions is in a fixed pattern.

15. The recycled tire pad with appliance pod recess guide of claim 11 wherein said plurality of textured protrusions is in a symmetrical predetermined pattern.

16. The recycled tire pad with appliance pod recess guide of claim 11 wherein shape of said textured protrusions is selected from the group consisting of circular, oval, square, rectangular, triangular, hexagonal, octagonal, polygonal, and combinations thereof.

17. The recycled tire pad with appliance pod recess guide of claim 11 wherein said plurality of bottom recesses is in a fixed pattern.

18. The recycled tire pad with appliance pod recess guide of claim 11 wherein said plurality of bottom recesses is in a symmetrical predetermined pattern.

19. The recycled tire pad with appliance pod recess guide of claim 11 wherein shape of said bottom recesses is selected from the group consisting of circular, oval, square, rectangular, triangular, hexagonal, octagonal, polygonal, and combinations thereof.

20. The recycled tire pad with appliance pod recess guide of claim 1 wherein each of said bottom recesses includes a top and a bottom and wherein an area of said bottom recess from a two-dimensional perspective parallel to said bottom of said at least one anti-vibration pad increases from said bottom of said bottom recess to said top of said bottom recess.
